(19) United States
(12) Patent Application Publication
(10) Pub. No.: US 2010/0203378 A1
(43) Pub. Date: Aug. 12, 2010

(54) DEVICE PROVIDING ELECTRICAL CONNECTION BETWEEN ELECTROCHEMICAL CELLS

(75) Inventors: Alexandre NARBONNE, Bordeaux (FR); Benoit TURBE, Bordeaux (FR); Thierry BERLUREAU, Bordeaux (FR); Christophe MORIN, Saint Aubin de Medoc (FR)

Correspondence Address: SUGHRUE MION, PLLC, 2100 PENNSYLVANIA AVENUE, N.W., SUITE 800, WASHINGTON, DC, 20037, US

(73) Assignee: SAFT GROUPE SA, Bagnolet (FR)

(21) Appl. No.: 12/697,822

(22) Filed: Feb. 1, 2010

(30) Foreign Application Priority Data
Feb. 6, 2009 (FR) 09/00519

(51) Int. Cl. H01M 2/26; H01R 9/00

(52) U.S. Cl. 429/160; 29/842

(57) ABSTRACT

There is provided an electrical connection device (1) between terminals (8a, 8a′, 8b, 8b′) of electrochemical storage battery cells (9a, 9b), which includes a first layer consisting of a metal substrate (4) for connecting two electrochemical cell terminals, and a second layer consisting of a printed electronic circuit (2) with electronic components (7) for measuring electrochemical cell parameters, the printed electronic circuit layer (2) being electrically and mechanically connected to the metallic substrate layer (4). The electrical connection device provides reliable connection with the terminals of storage cells and good heat dissipation.

### BACKGROUND OF THE INVENTION

The present invention relates to the electrical connection between electrochemical cells in a storage battery. More particularly, the invention concerns power connection between at least two electrochemical cells of a battery and the integration of a cell monitoring device along with the power connection devices.

Typically, a battery is made up of a plurality of electrochemical cells also called storage cells, or simply cells or elements. The electrochemical cells are connected to each other in series and/or in parallel by means of electrical connection devices forming a line for power. A known such device for the electrical connection between cells is described in JP-A-2007323951. Each electrochemical cell discharges by supplying electrical power to a given application. The battery can be charged by a charger supplying electrical energy to the battery terminals for increasing the amount of electrical energy stored in each electrochemical cell. For high power applications, it is necessary to provide a connection system of appreciable cross-section between cells. On the other hand, the use of an electronic circuit for electrochemical cell monitoring and management is known, the purpose of which is to monitor their state of charge and/or their health, notably by individual measurements of voltage or current or performing measurement on a group of storage cells.

The need for providing electrical connection as well as electronic monitoring discussed above can be handled by a mechanical assembly known as a busbar. A typical such busbar consists of small heavy cross-section bars providing the high power connection which are assembled onto a printed circuit. Such a busbar is for example employed in assignee's batteries sold under reference No. 750046 and incorporating a busbar reference No. 750762.

On a conventional busbar, the printed circuit includes electronic components making it possible to monitor cell parameters, these typically being current and voltage measuring components, temperature sensors or others. The connection bars are generally assembled using brazing or riveting onto the printed circuit while being connected to the cell terminals by screwing, brazing or welding. Current for the monitoring and/or management measurements on the cells is conducted by the brazed joints or rivets and routed to the electronic components of the circuit by printed tracks on the printed circuit. A busbar make it possible to integrate the monitoring electronics with the power connection and allows all of the connection bars to be positioned on the plurality of electrochemical cells in a single operation.

Nevertheless, the connection bars do need to be accurately positioned on the printed circuit and each require preparation prior to assembly such as cutting out, tooling, surface treatments or other operations which constitute a heavy investment. Secondly, it is difficult to master the process for assembling the connection bars onto the printed circuit. In particular, certain assembly processes are difficult to implement in the presence of electronic components. This results in a significant production reject rate, together with possible failures during use. These failures are all the more probable when we consider that the set of cell terminals of the battery does not generally constitute a perfect plane. This lack of flatness of the terminals sets up stresses in the brazed joints, rivets or welds which can rupture. It is also observed that the heating up of the connection bars when a heavy current is passing accelerates ageing of the electronic components integrated into the electronic circuit of the busbar, and sets up heavy stresses on component soldered joints.

So-called IMS (Insulated Metal Substrate) systems are also known. Such a system comprises a rigid or flexible printed circuit to which a metal substrate or baseplate, generally of aluminum, is secured. The printed circuit and metal substrate are assembled using a heat conducting adhesive. The printed circuit can include surface mounted electronic components. The metal substrate acts as a heat sink for cooling the components mounted on the printed circuit, but is not adapted for electrical conduction. The printed circuit is not in electric contact with the metal substrate.

JP-A-2003133660 discloses a flexible electric connection device in which the power supply lines and signal lines coexist. The electrical signal and power lines are arranged side-by-side on the same horizontal plane. A protective layer is arranged at both sides of the plane formed by these electrical lines. Such a device does not make it possible to mount surface mount components and does not provide good heat dissipation for currents circulating on the power lines.

GB-A-1 394 878 discloses a device in which an electrical power distribution layer and a signal transmission layer are provided at either side of an insulating layer. The device of this patent is designed for installation in buildings. The device is not suitable for monitoring and connecting electrochemical cells, nor for the mounting of electronic components. Additionally, it is not designed to favor heat dissipation.

WO-A-9 414 227 discloses an electrical connection device comprising conducting layers one on top of the other, separated by an insulator, and communicating with each other in some places. This system is adapted for use in a high power AC/DC converter. It is not flexible, does not allow electronic components to be mounted and is not suitable for the connection and monitoring of electrochemical cells.

### SUMMARY OF THE INVENTION

None of the devices discussed above is suitable for the connection and monitoring of electrochemical cells. There is consequently a need for a device for electrically connecting electrochemical cells in which electrical power connecting means and electronic measuring means are associated, which can be produced by relatively inexpensive techniques, which provides reliable electrical contacts and which makes it possible to limit ageing of the electronic components.

To this end, the invention provides a busbar designed starting out from an IMS (insulated metal substrate) type structure in which the printed circuit and metal substrate, mechanically secured one to the other, are also connected electrically. The printed circuit carries conductive tracks on one of its faces along with electronic components providing low current measurement for cell monitoring and management. The metal substrate which is secured to the opposite side of the printed circuit is employed for the passage of high currents between the terminals of the storage cells. This substrate additionally provides for dissipation of the heat produced by the components as well as dissipation of the heat generated by the passage of heavy currents in the substrate. Such a heat dissipating effect is particularly efficacious thanks to the large heat exchange surface between the substrate and the environment. The metal substrate can be cut out to provide connection regions which are electrically insulated from each other, in order to connect a plurality of storage cells.

More specifically, the invention provides an electrical connection device between terminals of at least two electrochemical cells, comprising:
a first layer consisting of a metal substrate adapted to connect at least two electrochemical cell terminals;
a second layer consisting of a printed electronic circuit including at least one electronic component adapted to measure at least one parameter of at least one electrochemical cell,

the printed electronic circuit layer being electrically and mechanically connected to the metallic substrate layer;

wherein the metal substrate of the first layer is cut out to define at least two connection regions, each connection region electrically connecting two terminals of electrochemical cells and having a surface area comprised between 25 mm² and 800 cm².

In various embodiments, the electrical connection device of the invention can comprise one or several of the following characteristics:
the printed electronic circuit layer and the metal substrate layer are electrically connected by rivets and/or plated-through holes and/or electrically conducting ink filled holes and/or metal pins and/or screws.
the printed electronic circuit layer is mechanically connected to the metal substrate layer by an electrically insulating adhesive layer, and/or by co-lamination, and/or by deposition of metal layers forming the metal substrate directly on one side of the printed electronic circuit layer.
the printed electronic circuit layer has a thickness comprised between 0.05 mm and 3.2 mm
the printed electronic circuit layer is provided in a flexible or semi-rigid material.
the metal substrate layer has a thickness comprised between 0.1 mm and 8 mm
the metal substrate layer is composed of a material having an electrical conductivity greater than 10 m. Ω⁻. mm⁻².

The invention also provides a battery comprising a plurality of electrochemical cells and at least one electrical connection device according to the invention

The invention also provides a method for manufacturing an electrical connection device for connecting terminals of at least two electrochemical cells, the method including the steps of:
mechanically assembling a metal substrate layer with a printed circuit layer;
cutting out the metal substrate layer in order to form connection regions, each connection region having a surface area comprised between 25 mm² and 800 cm²;
electrically assembling the connection regions of the metal substrate layer with electrical tracks of the printed circuit layer.

In various embodiments, the method for manufacturing an electrical connection device of the invention can comprise one or several of the following characteristics:
the mechanical assembly step includes a step of depositing metallic layers on the printed circuit layer.
the mechanical assembly step includes a step of co-rolling the metallic layer and the printed circuit layer.
the mechanical assembly step is preceded by a step of pre-cutting out of the metal substrate layer.
the step of cutting out the metal substrate layer further includes cutting out relief areas in the printed electronic circuit layer

Further characteristics and advantages of the invention will become more clear from reading the description which follows. This description is provided solely by way of example, and with reference to the attached drawings.

### BRIEF DESCRIPTION ON THE DRAWINGS

FIG. 1 is a diagrammatic cross-section view of a connection device according to the invention.

FIG. 2 is a graph illustrating the differences in heating up between a conventional busbar and the busbar according to the invention.

### DETAILED DESCRIPTION OF PREFERRED EMBODIMENTS

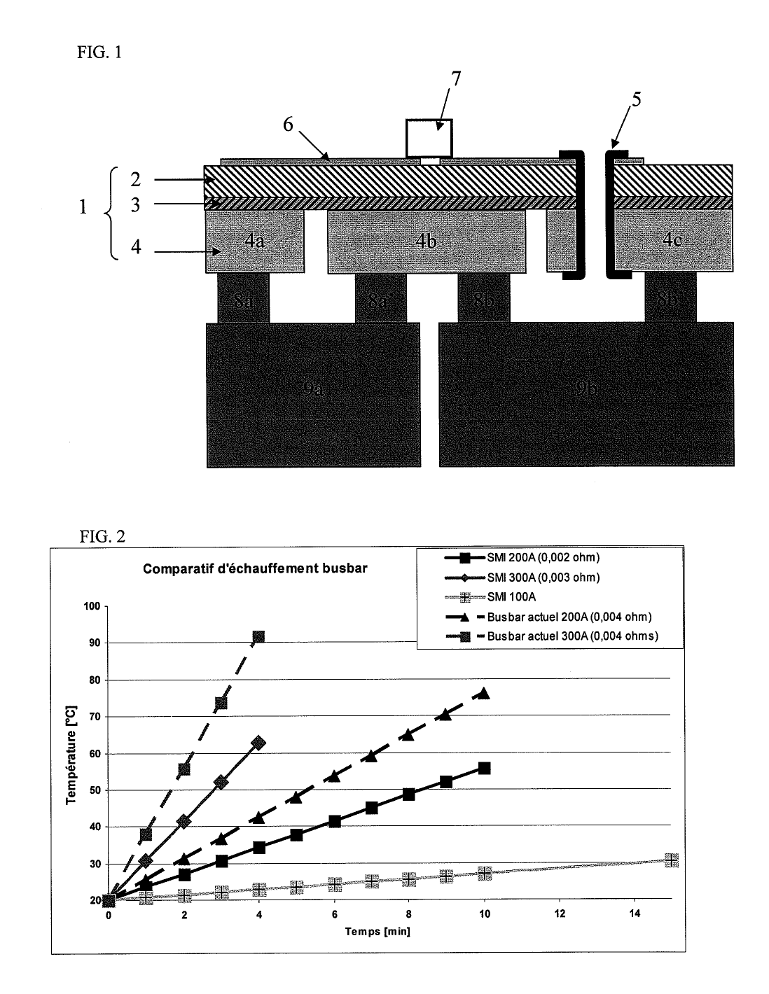

The invention provides a busbar type device made up of a measuring part and an electrical power part which are electrically and mechanically connected to each other. The structure of the device according to the invention will be described with reference to FIG. 1. In the diagram of FIG. 1, the various parts are not drawn to scale. FIG. 1 shows an electrical connection device 1 comprising a first layer 4 and the second layer 2. The first layer 4 covers substantially the whole surface of one side of the second layer 2.

FIG. 1 also shows two storage cells 9a and 9b with their respective output terminals 8a, 8a′ and 8b, 8b′. The connection device 1 of the invention makes it possible to join two storage cells 9a, 9b by electrically connecting their current output terminals 8a, 8a′ and 8b, 8b′ in an appropriate fashion. On FIG. 1, the cells 9a, 9b are illustrated each with two output terminals 8a, 8a′ and 8b, 8b; nevertheless, one of the two cell terminals can be constituted by the container itself. Such arrangements of the power output terminals of storage cells are well known. In FIG. 1, we have shown an assembly of two series-connected cells 9a, 9b; terminal 8a′ of a first cell 9a is connected to the terminal 8b of opposing polarity of a second storage cell 9b. The two cells 9a, 9b can be connected in parallel. In this case, it is the terminals 8a, 8b of the same polarity of both cells 9a, 9b which our connected together, and the terminals 8a′, 8b′ of opposing polarity are also connected together. It will be understood that FIG. 1 is diagrammatic and that the number of cells which are connected together in series and/or parallel using the connection device 1 of the invention can be much greater.

The first layer 4 of device 1 according to the invention constitutes a part we shall call the power part. This first layer consists of a metal substrate or baseplate 4 connecting the terminals of the storage cells in accordance with the desired electrical arrangement (series or parallel). The second layer 2 of device 1 of the invention we call the measuring part and this consists of a printed circuit 2 including at least one electronic component 7 adapted to measure at least one parameter of at least one storage cell. The printed electronic circuit layer 2 is mechanically connected to the layer consisting of the metal substrate 4, for example using an electrically insulating adhesive 3. The printed electronic circuit layer 2 is also electrically connected, for example by means of rivets 5, to the metal substrate layer 4.

In particular, the measuring part is constituted by a layer of printed electronic circuit 2 composed of a flexible material such as PEN (polyethylene naphthalate) or polyimide or of a semi-rigid flame retardant material such as FR4 (flame resistant 4). The thickness of printed electronic circuit layer 2 can be comprised between 0.05 mm and 3.2 mm depending on the material chosen. This printed electronic circuit layer 2 carries metallic tracks 6, for example of copper, which allow the electrical signals to be delivered to the electronic components 7. The electronic components 7 can be measuring components, temperature sensors, signaling devices, terminals, fuses, switches, microcontrollers, signal processing electronics, or others.

The power part is made up of a metal substrate layer 4 of thickness comprised between 0.1 and 8 mm. Metal substrate 4 can be for example composed of copper or alloys thereof, of aluminum or alloys thereof, of copper/zinc alloys treated or untreated with silver or nickel to provide effective electrical conduction. Metal substrate layer 4 provides transport of electrical power into and/or from the storage cells 9a, 9b via the terminals 8a, 8a′, 8b, 8b′ In order to enhance corrosion resistance, the material of metal substrate 4 can be of nickel, tin or nickel plus silver plated. Metal substrate 4 preferably consists of a material having an electrical conductivity better than 10 m. Ω⁻¹. mm⁻²

In one embodiment, if the number of cells 9a, 9b to be connected within the battery is greater than two, metal substrate layer 4 is then cut out to define a plurality of connection regions 4a, 4b, 4c, each region electrically connecting terminals 8a′, 8b′ of storage cells 9a, 9b in accordance with the desired arrangement (series connection in FIG. 1). These connection regions 4a, 4b, 4c can be of around 5 mm side for low-power applications, and up to 4 cm by 2 m for large size batteries.

For an equivalent cross-section, the connection regions 4a, 4b, 4c of the electrical connection device 1 of the invention have a more flat geometry, i.e. thinner and spread over a larger surface, than the small bars of a conventional busbar and consequently allow better heat dissipation. Typically, each connection region 4a, 4b, 4c of electrical connection device 1 can have a surface area comprised between 25 mm² and 800 cm². This extended geometry of the connection regions provides improved heat exchange surfaces between the connection regions and the printed circuit and between the connection regions and surrounding air when compared to the connection bars in a conventional busbar.

The printed electronic circuit layer 2 is mechanically connected to the metal substrate layer 4. This mechanical joint can be provided by an adhesive layer 3, for example an electrically insulating adhesive or by means of an adhesive tape such as the adhesive from the 3M® company sold under reference 9605. The metal substrate layer 4 can also be mechanically joined to the printed electronic circuit layer 2 directly, for example by depositing the metal substrate 4 on one side of the printed circuit 2 using a thin film deposition technique, or by direct the assembling the printed circuit 2 and metal substrate 4 layers by co-laminating them. In these cases, the presence of an intermediate adhesive layer 3 is no longer necessary. When an adhesive layer 3 is employed between the printed circuit layer 2 and metal substrate layer 4, the adhesive layer 3 is electrically insulating in order to avoid short-circuits between the connection regions 4a, 4b, 4c of the metal substrate. Adhesive layer 3 is for example chosen so as to have dielectric strength greater than or equal to 16 kV/mm Adhesive layer 3 may or may not be heat conducting. In effect, this adhesive layer 3 is relatively thin and does not constitute a barrier to conduction of heat between printed circuit layer 2 and metal substrate layer 4, even if not doped to render it heat conducting.

Unlike a conventional busbar, the mechanical connection between printed circuit layer 2 and the connection regions 4a, 4b, 4c with the regions 8a, 8a′ and 8b, 8b′ of storage cells 9a, 9b extend over the whole of the interface between printed circuit layer 2 and metal substrate layer 4. Such a mechanical connection is consequently easier and faster to establish than securing each individual bar to the printed circuit.

Unlike a conventional IMS structure, the printed electronic circuit layer 2 is also electrically connected to the metal substrate layer 4. In particular, the tracks 6 of printed circuit 2 can be connected via the connection regions 4a, 4b, 4c of metal substrate 4, to the terminals 8a, 8a′ and 8b, 8b′ of storage cells 9a, 9b. This electrical contact makes it possible to transport signals between the terminals 8a, 8a′, 8b, 8b′ of the cells 9a, 9b and the electronic components 7 provided on printed circuit 2. The electrical contact between printed electronic circuit layer 2 and the metal substrate layer 4 can be provided by rivets 5 and/or plated-through holes or conducting ink filled holes, or by any other means making it possible to establish electrical contact such as metal pins or screws, for example. When assembling electrical connection device 1 on to the terminals 8a, 8a′, 8b, 8b′ of the storage cells 9a, 9b, the printed electronic circuit layer 2 guarantees overall mechanical cohesion and keeps the connection regions 4a, 4b, 4c in position prior to their assembly onto the terminals 8a, 8a′, 8b, 8b′ of the storage cells 9a, 9b Relief cutouts can be provided in the form of cutout regions in metal layer 4 and optionally, in printed circuit layer 2 in order to further increase flexibility of the connection device 1 and thereby make it possible to compensate for irregularities in the height of the terminals 8a, 8a′, 8b, 8b′ of cells 9a, 9b.

The connection regions 4a, 4b, 4c of metal substrate 4 can be connected to the terminals 8a, 8a′, 8b, 8b′ of the storage cells 9a, 9b by screwing, riveting, electric welding, laser welding, ultrasound welding, or friction welding or any other suitable technique. Implementing the connection between metal substrate 4 and the terminals 8a, 8a′, 8b, 8b′ of the storage cells 9a, 9b may necessitate local elimination of the printed circuit 2 and adhesive 3 layers, to allow for the passage of screws or the tools needed for the chosen method of brazing/welding.

The invention also provides a method for producing the electrical connection device 1 between storage cells 9 discussed above. Mechanical assembly between metal substrate layer 4 and printed electronic circuit layer 2 can be obtained using laminating or rolling processes. Lamination is preferably employed for printed electronic circuit layers 2 which are semi-rigid such as those made of FR4 for example. Pre-assembly of the metal substrate layer 4 with the FR4 layer is firstly performed with a layer of adhesive 3 at the interface of the two layers. The preassembled structure is then introduced into a press for an appropriate period of time to allow stable bonding between the layer of FR4 and metal substrate layer 4. A method of rolling or thermo-bonding is preferred for the layers of the printed electronic circuit 2 of (PEN, polyimide) flexible film. Firstly, pre-assembly of the layer of metal substrate 4 with the flexible film is performed using an adhesive 3 at the interface of the two layers. The preassembled structure is then passed through a set of compression rollers for establishing stable mechanical contact between the two layers. The layers of printed circuit 2 and metal substrate 4 can then be directly co-laminated without pre-assembly using an adhesive layer. Regardless of whether mechanical assembly of the metal substrate layer 4 with the printed electronic circuit layer 2 is done by lamination or rolling, the average time this step occupies is well below that required for assembling the bars onto a conventional busbar. Typically, this assembly step takes a few minutes if we consider the case of rolling, as compared to around one hour for securing 8 small bars onto a conventional busbar. Metal substrate layer 4 can also be directly obtained by metal thin film deposition on one side of the printed circuit layer 2 (the opposite side to the one carrying the electronic components 7). In this case, mechanical assembly is achieved by a technique in which the metal substrate layer 4 is produced on the printed electronic circuit layer 2.

Once assembled onto the flexible or semi-rigid printed electronic circuit layer 2, metal substrate layer 4 can be cut out in order to obtain a plurality of connection regions 4a, 4b, 4c when there are more than two electrochemical cells 9a, 9b to be connected. Consequently, unlike conventional busbars, assembly of small individual bars on a printed circuit is not involved. The method of production according to the invention is more accurate, faster, and less expensive. Metal substrate layer 4 can be cut out by machining, milling, stamping, chemical etching, water jet cutting or laser cutting. Relief areas can be cut out in printed circuit layer 2 during this step.

In one embodiment, metal substrate layer 4 can be partially cut out prior to pre-assembly, notably where the substrate 4 is thick and/or when there are a great number of connection regions to be made. In effect, it can be preferable to perform part of the cutting out before pre-assembly, in order to limit stresses on the printed electronic circuit layer 2. Pre-cutting out can then be followed by the remainder of the cutting out after assembly, allowing the process of cutting out the metal substrate layer 4 and the creation of relief cut out portions in printed circuit layer 2 to be achieved.

The electrical connection device of the invention is faster to produce than a conventional busbar and provides for reliable connection with the terminals 8a, 8a′, 8b, 8b′ of the electrochemical cells 9a, 9b.

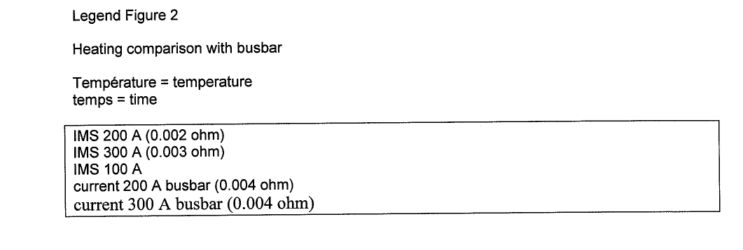

Further advantages of the invention over the conventional busbar will be obvious when we look at FIG. 2.

In conventional busbars, the connection bar generally has a thickness of 3 to 4 mm thick and a width of 12 to 16 mm leading to a cross-section around 50 mm² The measurements illustrated in FIG. 2 were obtained on a conventional busbar and on an electrical connection device 1 according to the invention. The connection device employed for the measurements in FIG. 2 had a metal substrate layer 4 having a thickness of about 1.5 mm and a width of about 35 mm leading to a cross-section around 50 mm². As mentioned above, for an equivalent cross-section, the connection regions 4a, 4b, 4c of electrical connection device 1 of the invention have a flatter and extended geometry compared with the bars of a conventional busbar, thereby allowing better thermal dissipation. This extended geometry provides for improved heat exchange surfaces with the printed circuit and the surrounding environment compared to the connection bars in a conventional busbar. It will be further noticed in FIG. 2 that connection device 1 exhibits less heating up when compared to a conventional busbar.

The graph in FIG. 2 shows heating up for a conventional busbar and for a connection device according to the invention carrying different currents. Notably, the graph in FIG. 2 shows temperature as a function of time, the temperature being measured on one hand, on a conventional busbar having a cross-section of 50 mm² and a resistivity of 0.004 ohm and on the other hand, on the metal substrate of a connection device according to the invention having a cross-section of 50 mm² and a resistivity comprised between 0.002 ohm and 0.003 ohm. The temperatures were measured of different currents flowing through the connections.

For a 100 A current (light gray curves), it can be seen that the heating up in the connection device according to the invention remains limited; less than 30° after more than 10 minutes. For a 300 A current (dark gray curves), the heating up of the connection device according to the invention (plain curve) is comprised between 60° C. and 70° C. after 4 minutes, which is about 30° C. less than the heating up of a conventional busbar (dotted curve) for the same current. For a 200 A current (black curves), the heating up of the connection device according to the invention (plain curve) is comprised between 50° C. and 60° C. after 10 minutes, which is about 20° C. less than the heating up of a conventional busbar (dotted curve) for the same current

Thermal dissipation of the connection device according to the invention is far more important than that of a conventional busbar because of the larger surface area of the connection regions, comprised between 25 mm² and 800 cm² allowing a very good heat exchange with surrounding air.

The connection regions 4a, 4b, 4c of the electrical connection device 1 according to the invention are, on the other hand, more deformable when compared to the connection bars of a conventional busbar, as they are thinner. This capability to deform makes it possible to improve contact between the contact regions 4a, 4b, 4c and the terminals 8a, 8a′, 8b, 8b′ of the electrochemical cells 9a, 9b, by accommodating deficiencies in flatness. This improved electrical contact between electrical connection device 1 and the terminals 8a, 8a′, 8b, 8b′ taking the current from the cells 9a, 9b makes possible a reduction in electrical contact resistance of up to twice as low, when compared to a conventional busbar. Heating up under heavy currents is consequently reduced.

The electrical connection device 1 between electrochemical cells 9a, 9b according to the invention consequently makes it possible to associate, within one device, electrical power connection means and electronic measuring means. This device is easy to produce, gives relief from constraints associated with irregularities in the heights of terminals 8a, 8a′, 8b, 8b′ of the electrochemical cells 9a, 9b, shows good thermal dissipation thereby improving electronic component durability, and has reduced electrical contact resistance with the terminals 8a, 8a′, 8b, 8b′ of the electrochemical cells 9a, 9b.

The invention also provides a battery comprising a plurality of electrochemical cells 9a, 9b and at least one electrical connection device 1 according to the invention. The electrochemical cells 9a, 9b can be of any type, such as Li-ion, Ni—MH, Ni—Cd or otherwise. The electrical connection device 1 of the invention can be employed on a battery comprising at least two electrochemical cells 9a, 9b. How metal substrate 4 is cut out is determined by the number of cells to be connected. The electrical connection device of the invention can consequently be fitted onto a battery typically comprising several tens of electrochemical cells.

1. An electrical connection device between terminals of at least two electrochemical cells the connection device comprising:
a first layer consisting of a metal substrate,
a second layer consisting of a printed electronic circuit including at least one electronic component adapted to measure at least one parameter of at least one electrochemical cell, wherein the printed electronic circuit layer is electrically and mechanically connected to the metallic substrate layer;
wherein the metal substrate of the first layer is cut out to define at least two connection regions,
wherein each connection region is adapted to electrically connect two terminals, and
wherein each connection region has a surface area comprised between 25 mm² and 800 cm².

2. The device according to claim 1, in which the printed electronic circuit layer and the metal substrate layer are electrically connected by rivets and/or plated-through holes and/or electrically conducting ink filled holes and/or metal pins and/or screws.

3. The device according to claim 1, in which the printed electronic circuit layer is mechanically connected to the metal substrate layer by an electrically insulating adhesive layer, and/or by co-lamination, and/or by deposition of metal layers forming the metal substrate directly on one side of the printed electronic circuit layer.

4. The device according to claim 1, in which the printed electronic circuit layer has a thickness comprised between 0.05 mm and 3.2 mm.

5. The device according to claim 1, in which the printed electronic circuit layer is provided in a flexible material.

6. The device according to claim 1, in which the printed electronic circuit layer is provided in a semi-rigid material.

7. The device according to claim 1, in which the metal substrate layer has a thickness comprised between 0.1 mm and 8 mm.

8. The device according to claim 1, in which the metal substrate layer is composed of a material having an electrical conductivity greater than 10 m. Ω⁻¹. mm⁻².

9. The device according to claim 1, heating up to a temperature comprised between 60° C. and 70° C. after 4 minutes for a current of 300 A flowing through the metal substrate.

10. The device according to claim, 1 heating up to a temperature comprised between 50° C. and 60° C. after 10 minutes for a current of 200 A flowing through the metal substrate.

11. A battery comprising a plurality of electrochemical cells, each cell having electrical terminals, the battery further comprising at least one electrical connection device comprising:
a first layer consisting of a metal substrate,
a second layer consisting of a printed electronic circuit including at least one electronic component adapted to measure at least one parameter of at least one electrochemical cell,
the printed electronic circuit layer being electrically and mechanically connected to the metallic substrate layer;
wherein the metal substrate of the first layer is cut out to define at least two connection regions,
wherein each connection region electrically connects two terminals, and
wherein each connection region has a surface area comprised between 25 mm² and 800 cm².

12. The battery according to claim 11, in which the electrical connection device heats up to a temperature comprised between 60° C. and 70° C. after 4 minutes for a current of 300 A flowing through the metal substrate.

13. The battery according to claim 11, in which the electrical connection device heats up to a temperature comprised between 50° C. and 60° C. after 10 minutes for a current of 200 A flowing through the metal substrate.

14. The battery according to claim 11, in which the metal substrate layer of the electrical connection device has a thickness comprised between 0.1 mm and 8 mm.

15. The battery according to claim 11, in which the metal substrate layer of the electrical connection device is composed of a material having an electrical conductivity greater than 10 m. Ω^{31 1}. mm².

16. A method for manufacturing an electrical connection device for connecting terminals of at least two electrochemical cells, the method including the steps of:
mechanically assembling a metal substrate layer with a printed circuit layer;
cutting out the metal substrate layer in order to form connection regions, each connection region having a surface area comprised between 25 mm² and 800 cm²;
electrically assembling the connection regions of the metal substrate layer with electrical tracks of the printed circuit layer.

17. The method for manufacturing an electrical connection device according to claim 16, in which the mechanical assembly step includes a step of pre-assembly by bonding followed by consolidation by compression.

18. The method for manufacturing an electrical connection device according to claim 16, in which the mechanical assembly step includes a step of depositing metallic layers on the printed circuit layer.

19. The method for manufacturing an electrical connection device according to claim 16, in which the mechanical assembly step includes a step of co-rolling the metallic layer and the printed circuit layer.

20. The method for producing an electrical connection device according to claim 16, in which the mechanical assembly step is preceded by a step of pre-cutting out of the metal substrate layer.

21. he method for producing an electrical connection device according to claim 16, in which the step of cutting out the metal substrate layer further includes cutting out relief areas in the printed electronic circuit layer.
